(19) United States
(12) Patent Application Publication
(10) Pub. No.: US 2016/0371763 A1
(43) Pub. Date: Dec. 22, 2016

(54) PAGE DISPLAY METHOD AND APPARATUS

(71) Applicant: Xiaomi Inc., Beijing (CN)

(72) Inventors: Yang WANG, Beijing (CN); Changbing CHEN, Beijing (CN); Qiang FU, Beijing (CN); Enxing HOU, Beijing (CN)

(73) Assignee: Xiaomi Inc., Beijing (CN)

(21) Appl. No.: 15/184,193

(22) Filed: Jun. 16, 2016

Related U.S. Application Data
(63) Continuation of application No. PCT/CN2015/078118, filed on Apr. 30, 2015.

(30) Foreign Application Priority Data
Dec. 11, 2014 (CN) 201410766415.X

(51) Int. Cl. G06Q 30/06; G06F 17/30; G06F 3/0484

(52) U.S. Cl. CPC G06Q 30/0631; G06F 3/04842; G06F 17/30905; G06F 3/04817

(57) ABSTRACT

The present disclosure relates to a page display method and a page display method apparatus, the page display method includes: obtaining an identifying element applied to a current display page, in which the identifying element matches an associated object of a displayed object in the current display page; displaying the identifying element in a display area associated with the displayed object and in the current display page.

### PRIORITY STATEMENT

This application is a continuation of International Application No. PCT/CN2015/078118, filed with the State Intellectual Property Office of P. R. China on Apr. 30, 2015, which is based upon and claims priority to Chinese Patent Application No. 201410766415.X, filed on Dec. 11, 2014, the entire contents of which are incorporated herein by reference.

### TECHNICAL FIELD

The present disclosure relates to an Internet technology field, and more particularly, to a page display method, and a page display apparatus.

### BACKGROUND

When a user is browsing through a website for online shopping, the website may display a product that the user is reading as well as a few other recommended objects in the web pages or APP (Application) pages for the user, and then the user may browse information of each displayed object respectively. However, the recommended objects normally are simply general recommendations from the website rather than after an analysis of the need from the user. For example, the website may recommend other objects to the user based on a standard that “what other users who buy the currently displayed product may also browse?” The current user, when seeing the recommendation, may not know whether the recommended objects is truly related to the product he/she is browsing, and the user may have to click the recommended objects one by one in order to read detailed descriptions thereof. This way of recommending objects to a user is inefficient and unprecise.

### SUMMARY

The present disclosure provides a page display method, and a page display apparatus to solve problems existing in the related art. For example, the present disclosure provides a solution to increase efficiency and accuracy of recommending a related product to a user who is currently browsing on a webpage.

According to an aspect of the present disclosure, an electronic device may comprise a processor-readable storage medium including a set of instructions for displaying a page; and a processor in communication with the storage medium. When executing the set of instructions, the processor is directed to: display a current display page on a screen of the electronic device; display a displayed object on a current display page, wherein the displayed object has a predetermined association relationship with an associated object; obtaining an identifying element indicating the predetermined association relationship; and display the identifying element on the current display page

According to another aspect of the present disclosure, a method for displaying a page may comprises displaying, by an electronic device, a current display page on a screen of the electronic device; displaying, by the electronic device, a displayed object on a current display page, wherein the displayed object has a predetermined association relationship with an associated object; obtaining, by the electronic device, an identifying element indicating the predetermined association relationship; and displaying, by the electronic device, the identifying element on the current display page.

According to yet another aspect of the present disclosure, a non-transitory processor-readable storage medium may comprise a set of instructions for displaying a page. When executed by a processor of an electronic device, the set of instruction directs the processor to perform: displaying a current display page on a screen of the electronic device; displaying a displayed object on a current display page, wherein the displayed object has a predetermined association relationship with an associated object; obtaining an identifying element indicating the predetermined association relationship; and displaying the identifying element on the current display page.

The technical solutions provided in embodiments of the present disclosure may have advantageous effects as follows.

With the technical solutions of the present disclosure, by displaying an identifying element of an associated object in a display area associated with a corresponding displayed object, a user may understand an association relationship between the displayed object and the associated object according to the identifying element without taking a view and making a confirmation one by one according to guesses, thus facilitating to improve the user's browsing efficiency.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing a page display method according to an exemplary embodiment.

FIGS. 2, 3A, and 3B are schematic diagrams illustrating an interface according to an exemplary embodiment.

FIG. 4 is a schematic diagram illustrating an association relationship of objects according to an exemplary embodiment.

FIGS. 5, 6, 7, 8, 9A, 9B, 10A, 10B, 11A, and 11B are schematic diagrams illustrating an interface according to an exemplary embodiment.

FIGS. 12-13 are block diagrams showing a page display apparatus according to an exemplary embodiment.

FIG. 14 is a block diagram showing a device for displaying a page according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The present disclosure provides a page display method, and a page display apparatus to solve problems existing in the related art. For example, the present disclosure provides a solution to increase efficiency and accuracy of recommending related products to a user who is currently browsing on a webpage. The relevant products may be generally relevant to the object, or alternatively, the relevant products may be limited only to specific products, such as products and/or parts that can be used by the object. For example, if the user is browsing a particular model of a cell phone, the relevant product may be parts of the cell phone or products that have been proved to be applicable and/or implementable in the cell phone, such as protective cases or protective screens specially designed for the cell phone of the particular model. The relevant and/or recommended product may be pre-determined and/or pre-defined for the particular object, rather than randomly selected.

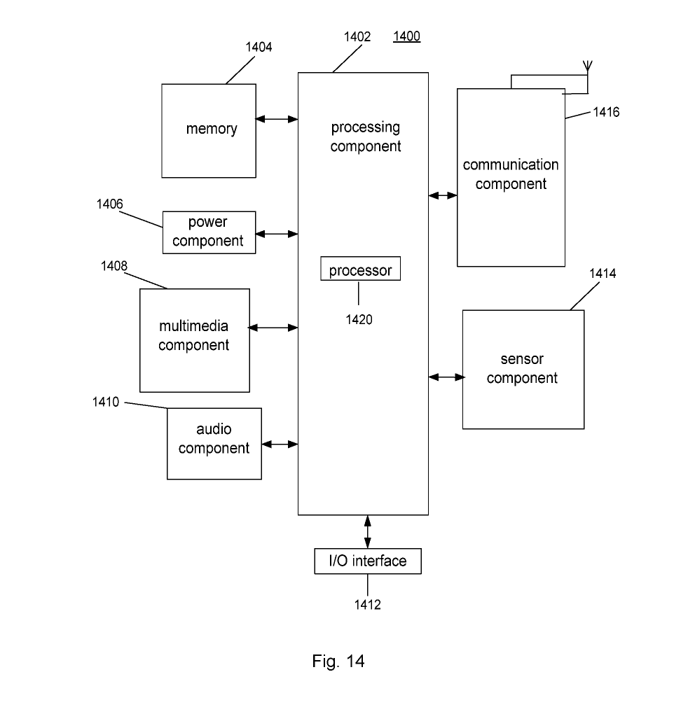

FIG. 14 is a block diagram of a device 1400 for displaying a page according to an exemplary embodiment. For example, the device 1400 may be a mobile phone, a computer, a digital broadcast terminal, a messaging device, a gaming console, a tablet, a medical device, an exercise equipment, a personal digital assistant, and the like.

Referring to FIG. 14, the device 1400 may include one or more of the following components: a processing component 1402, a memory 1404, a power component 1406, a multimedia component 1408, an audio component 1410, an input/output (I/O) interface 1412, a sensor component 1414, and a communication component 1416.

The processing component 1402 generally controls overall operations of the device 1400, such as the operations associated with display, telephone calls, data communications, camera operations, and recording operations. The processing component 1402 may include one or more processors 1420 to execute instructions to perform all or part of the steps in the above described methods. Moreover, the processing component 1402 may include one or more modules which facilitate the interaction between the processing component 1402 and other components. For instance, the processing component 1402 may include a multimedia module to facilitate the interaction between the multimedia component 1408 and the processing component 1402.

The memory 1404 is configured to store various types of data to support the operation of the device 1400. Examples of such data include instructions for any applications or methods operated on the device 1400, contact data, phonebook data, messages, pictures, videos, etc. The memory 1404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1406 provides power to various components of the device 1400. The power component 1406 may include a power management system, one or more power sources, and any other components associated with the generation, management, and distribution of power in the device 1400.

The multimedia component 1408 includes a screen providing an output interface between the device 1400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1408 includes a front camera and/or a rear camera. The front camera and the rear camera may receive an external multimedia datum while the device 1400 is in an operation mode, such as a photographing mode or a video mode. Each of the front camera and the rear camera may be a fixed optical lens system or have focus and optical zoom capability.

The audio component 1410 is configured to output and/or input audio signals. For example, the audio component 1410 includes a microphone (“MIC”) configured to receive an external audio signal when the device 1400 is in an operation mode, such as a call mode, a recording mode, and a voice recognition mode. The received audio signal may be further stored in the memory 1404 or transmitted via the communication component 1416. In some embodiments, the audio component 1410 further includes a speaker to output audio signals.

The I/O interface 1412 provides an interface between the processing component 1402 and peripheral interface modules, such as a keyboard, a click wheel, buttons, and the like. The buttons may include, but are not limited to, a home button, a volume button, a starting button, and a locking button.

The sensor component 1414 includes one or more sensors to provide status assessments of various aspects of the device 1400. For instance, the sensor component 1414 may detect an open/closed status of the device 1400, relative positioning of components, e.g., the display and the keypad, of the device 1400, a change in position of the device 1400 or a component of the device 1400, a presence or absence of user contact with the device 1400, an orientation or an acceleration/deceleration of the device 1400, and a change in temperature of the device 1400. The sensor component 1414 may include a proximity sensor configured to detect the presence of nearby objects without any physical contact. The sensor component 1414 may also include a light sensor, such as a CMOS or CCD image sensor, for use in imaging applications. In some embodiments, the sensor component 1414 may also include an accelerometer sensor, a gyroscope sensor, a magnetic sensor, a pressure sensor, or a temperature sensor.

The communication component 1416 is configured to facilitate communication, wired or wirelessly, between the device 1400 and other devices. The device 1400 can access a wireless network based on a communication standard, such as WiFi, 2G, or 3G, or a combination thereof. In one exemplary embodiment, the communication component 1416 receives a broadcast signal or broadcast associated information from an external broadcast management system via a broadcast channel. In one exemplary embodiment, the communication component 1416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer/processor readable storage medium including instructions, such as included in the memory 1404, executable by the processor 1420 in the device 1400, for performing methods that are introduced in the present disclosure. For example, the non-transitory computer-readable storage medium may be a ROM, a RAM, a CD-ROM, a magnetic tape, a floppy disc, an optical data storage device, and the like. The methods may be implemented in the device 1400 as a set of instructions stored in the non-transitory computer/processor readable storage medium. Consequently, when the processor 1420 of the device 1400 communicates with the storage medium and execute the set of instructions, the processor 1420 may perform operations in the methods.

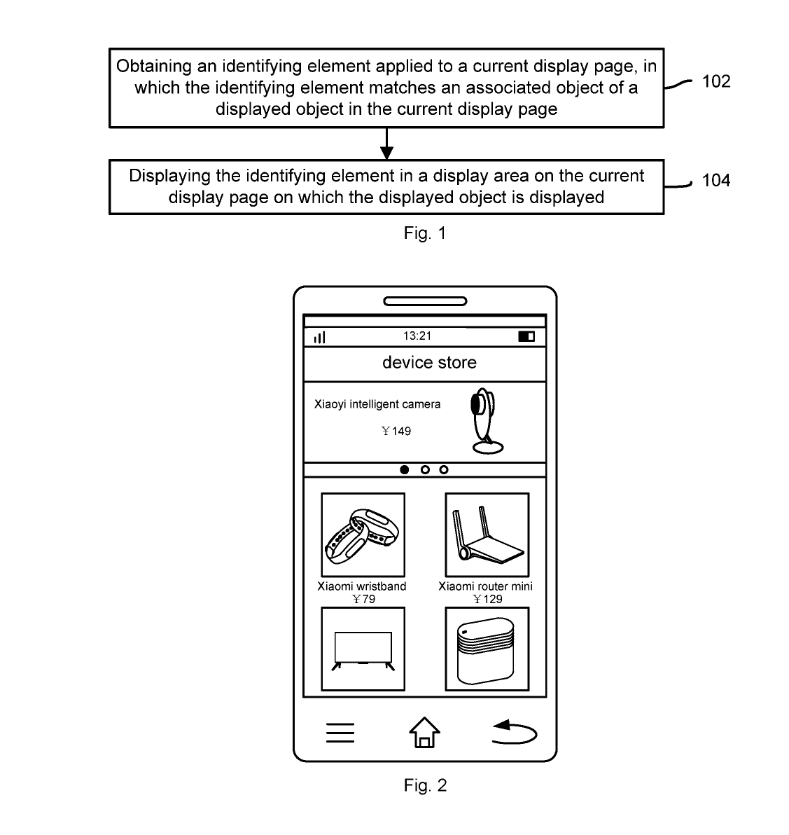

FIG. 1 is a flow chart showing a page display method according to an exemplary embodiment. The method may be implemented in a terminal, e.g., the method may be implemented as a set of instructions in the storage medium of the device 1400 and may be executed by the processor 1420 of the device 1400. The method may include the following steps.

In step 102, obtaining an identifying element applied to a current display page, in which the identifying element matches an associated object of a displayed object in the current display page.

In this embodiment, the current display page includes a displayed object, and the displayed object is associated with one or more associated objects. The associated object is an object different from the displayed object, and the associated object has a predetermined association relationship with the displayed object. The association relationship may exist between devices that may be used together. For example, a webcam that may be connected to a laptop computer may be an associated object of the laptop computer. Therefore, a laptop computer and a compatible webcam may be associated objects with respect to teach other. The association relationship may also exist between accessories of a device. For example, parts of a mobile phone may be associated objects with respect to each other, and a power supply may also be an associated object to the mobile phone.

The associated object may be displayed in the current display page to form another displayed object; or the associated object may be an object not displayed in the current display page, but may be displayed in another display page by replacing the display page.

In this embodiment, there are various types of association relationships between objects. For example, the associated object may be a whole device, and the displayed object may be an accessory of the whole device, for example, the associated object is a “Xiaomi mobile phone” while the displayed object is a “screen film”, a “mobile phone back cover”, etc.; or the displayed object may be another whole device cooperated with the associated object. Here, two independent devices are cooperated with each other when the two devices each is configured to perform part of a predetermined function and can be used together to complete the predetermined function. For example, the associated object is the “Xiaomi mobile phone” while the displayed object is a “mobile power bank”, a “Bluetooth headset”, etc.

Alternatively, the associated object may be an accessory, and the displayed object may be a whole device corresponding to the accessory, for example, the associated object is the “screen film” while the displayed object is the “Xiaomi mobile phone”; or the displayed object may be another accessory applied to a same whole device with the associated object, for example, the associated object is the “screen film” while the displayed object is the “mobile phone back cover.”

In step 104, displaying the identifying element in a display area on the current display page on which the displayed object is displayed.

Traditionally, after buying the “Xiaomi mobile phone” when a user hopes to find all accessories and whole devices (i.e. the associated objects) applied to the “Xiaomi mobile phone,” the user generally is required to understand all available accessories and whole devices in advance so as to browse these accessories and whole devices directly, otherwise the user is required to browse many objects one by one, which affects a user's browsing efficiency greatly.

In this embodiment, by displaying the identifying element of the associated objects in the display area associated with the displayed object, the user is just required to browse a display page of the “Xiaomi mobile phone”, but is not required to understand in advance or browse the associated objects one by one, i.e. if the “Xiaomi mobile phone” is used as the displayed object of the current display page, the identifying element of the associated object may be browsed in the associated display area corresponding to the “Xiaomi mobile phone”, such that all accessories and whole devices applied to the “Xiaomi mobile phone” are determined.

The following technical solutions of the above traditional problem will be described in detail by taking a “device store” displayed on a mobile phone as an example. A person of ordinary skill in the art should understand that the technical solutions of the present disclosure may be applied to various kinds of display pages in various kinds of electronic devices, which are not limited in the present disclosure.

1. Associated Display Area

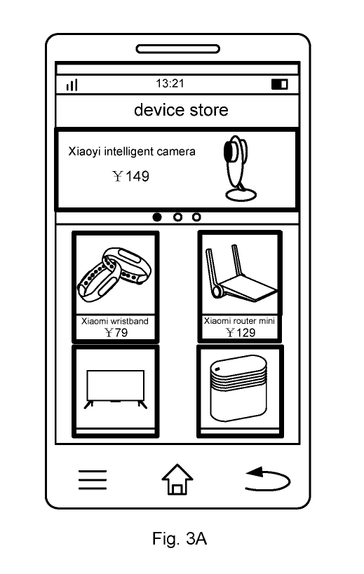

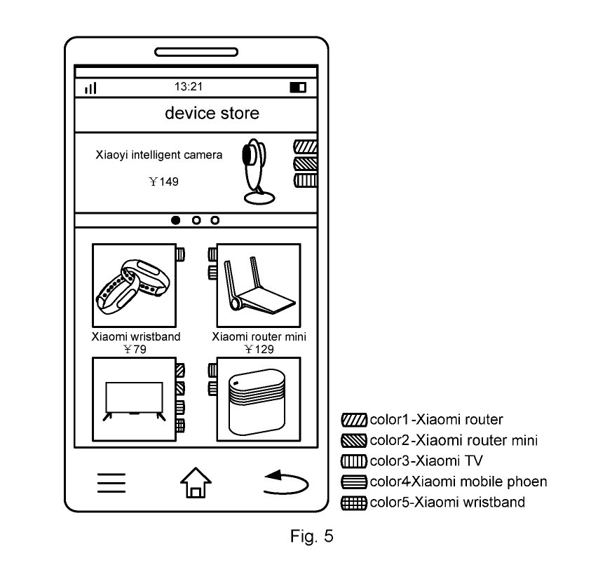

FIG. 2 is a schematic diagram illustrating an interface of a mobile phone according to an exemplary embodiment. The page displayed on the mobile phone may be a home page of a “device store.” Five displayed objects are illustrated in FIG. 2, namely: a “Xiaoyi intelligent camera” at the top, a “Xiaomi wristband” and a “Xiaomi router mini” in the middle and a “Xiaomi TV” and a “Xiaomi router” at the bottom. Here, FIG. 5 only illustrates the corresponding thumbnail images of the above five objects. When the page is scrolled upward or moved upward, the mobile phone may display corresponding texts of the five objects.

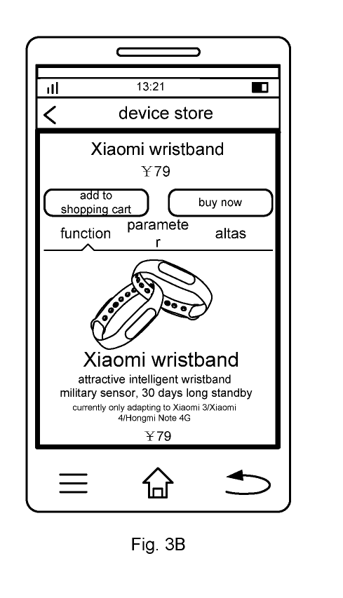

As an exemplary embodiment, for the home page of the “device store” illustrated in FIG. 2, FIG. 3A illustrates associated display areas corresponding to each displayed object. The associated display areas are bordered by thick lines. It may be seen that, the home page of the “device store” includes a plurality of displayed objects, and the display area associated with each displayed object is positioned around the each displayed object, so that an association relationship between the “displayed object” and the “display area” is established visually to avoid a false identification.

As another exemplary embodiment, if any one of the displayed objects in FIG. 2 is triggered, the user may browse a corresponding detail page, for example, FIG. 3B illustrates that a detail page of the “Xiaomi wristband” is displayed if the user clicks the “Xiaomi wristband.” Since FIG. 3B includes only one displayed object “Xiaomi wristband”, the false identification does not occur, thus any position in the whole detail page may be used as the display area associated with the “Xiaomi wristband.”

2. Association Relationship

As described above, the object displayed on the mobile phone may be a whole device or one or more accessories, and the displayed object may have an association relationship with one or more associated objects, e.g., the association relationship may be an association relationship between one whole device and another whole device, an association relationship between the accessory and the whole device, or an association relationship between one accessory and another accessory. Base on the whole devices (such as the Xiaomi wristband, the Xiaomi TV, etc.) illustrated in FIG. 2, taking the association relationship between one whole device and another whole device as an example, the association relationship will be described in detail in the following.

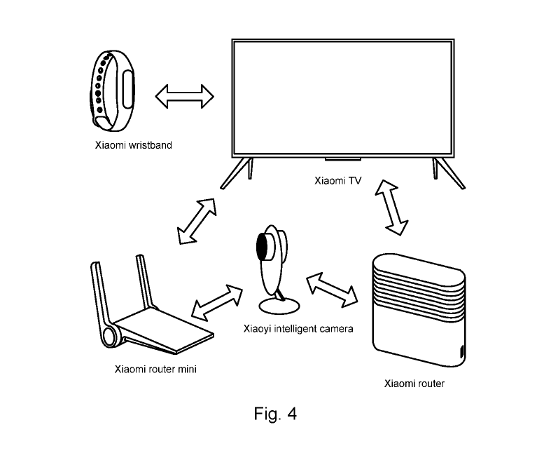

FIG. 4 is a schematic diagram illustrating a complex association relationship of between objects such as the Xiaoyi intelligent camera, the Xiaomi wristband, the Xiaomi TV, the Xiaomi router mini, the Xiaomi router and the like illustrated in FIG. 2. For example, the Xiaoyi intelligent camera may be applied to and/or connected to the Xiaomi TV, the Xiaomi router mini and the Xiaomi router, thus there may be association relationships of “the Xiaoyi intelligent camera—the Xiaomi TV”, “the Xiaoyi intelligent camera—the Xiaomi router mini” and “the Xiaoyi intelligent camera—the Xiaomi router.” The Xiaomi wristband may be applied to and/or connected to the Xiaomi TV, thus there may be an association relationship “the Xiaomi wristband—the Xiaomi TV”, and so on.

Therefore, according to a combination and a coordination application relationship between objects, the association relationships of objects may be determined in advance, thus realizing a display of a corresponding identifying element.

3. Display of an Identifying Element

A person of ordinary skill in the art should understand that, any element which may be used to distinguish and mark different objects may be used as the identifying element in the technical solutions of the present disclosure, for example, the identifying element may include at least one of a color, a texture and an icon.

Assume that there are association relationships shown in Table 1 of the displayed objects.

TABLE 1

| | associated | associated | associated | associated |
|---|---|---|---|---|
| Display object | object 1 | object 2 | object 3 | object 4 |
| Xiaoyi | Xiaomi | Xiaomi router | Xiaomi TV | / |
| intelligent | router | mini | | |
| camera | | | | |
| Xiaomi | Xiaomi TV | / | / | / |
| wristband | | | | |
| Xiaomi | Xiaomi TV | Xiaoyi | / | / |
| router | | intelligent | | |
| mini | | camera | | |
| Xiaomi TV | Xiaomi | Xiaomi router | Xiaoyi | Xiaomi |
| | router | mini | intelligent | wristband |
| | | | camera | |
| Xiaomi | Xiaomi TV | Xiaoyi | / | / |
| router | | intelligent | | |
| | | camera | | |

As an exemplary embodiment, for the home page of the “device store”, FIG. 5 illustrates the identifying element of the corresponding associated object displayed in the display area associated with each displayed object, i.e. “the color.” As shown in FIG. 5, in the display area corresponds to the display area illustrated in FIG. 3A, each identifying element displaying the corresponding associated object may be displayed in a form of color blocks shown in FIG. 5.

Of course, since the drawings only use black and white line patterns to illustrate, in order to not affect the display effects of the drawings, the color blocks may be adopted in FIG. 5. According to an exemplary embodiment, the mobile phone may adjust colors of the image, text of the displayed object to achieve a better or optimal visual effect. For example, the mobile phone may adopt a larger size to the color blocks and may incorporate color 1, color 2, color 3, color 4 and/or color 5 into the images of the displayed objects (e.g., the mobile may incorporate the color or colors in the displayed object “Xiaomi wristband” by incorporating the color or colors in the rectangular box above the text “Xiaomi wristband” and surrounding the Xiaomi wristband icon/image).

In addition, the color corresponding to each object in FIG. 5 may be a single color or a mixed color. For example, the “Xiaomi router” is corresponding to “color 1”, however, this “color 1” may be a pure color (such as a red color), may also be a combination of various colors (such as a red and white color combination).

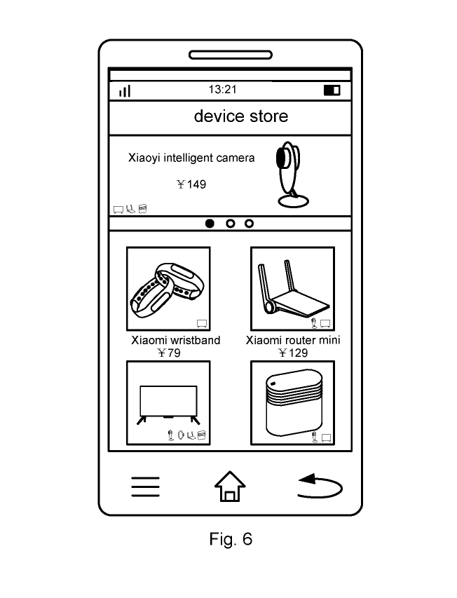

As another exemplary embodiment, still taking the home page of the “device store” as an example, FIG. 6 illustrates that a form of an “icon” is adopted as the identifying element of the associated object. As shown in table 1, the associated objects of the “Xiaoyi intelligent camera” may be the “Xiaomi TV”, the “Xiaomi router mini” and “the Xiaomi router”, thus icons corresponding to the above-described associated objects may be displayed in the display area associated with the “Xiaoyi intelligent camera.” Therefore, the user may understand the association relationships of these objects directly, i.e. the “Xiaoyi intelligent camera” may be connected to and used together with the “Xiaomi TV”, the “Xiaomi router mini” and the “the Xiaomi router.”

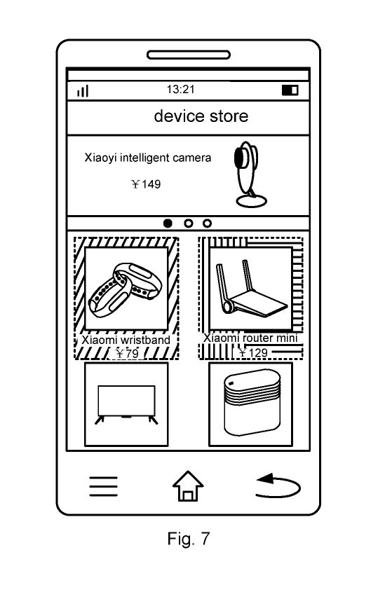

As another exemplary embodiment, still taking the home page of the “device store” as an example, FIG. 7 illustrates that a form of “texture” is adopted as the identifying element of the associated object. For ease of description, assuming that the “Xiaomi wristband” is just associated with the “Xiaomi mobile phone” while the “Xiaomi router mini” is associated respectively with the “Xiaoyi intelligent camera” and the “Xiaomi TV” in FIG. 7, accordingly, a diagonal stripe pattern corresponding to the “Xiaomo mobile phone” may be used as a texture of the display area associated with the “Xiaomi wristband”, and a combination of a horizontal stripe pattern and a vertical stripe pattern corresponding respectively to the “Xiaoyi intelligent camera” and the “Xiaomi TV” may be used as the texture of the display area associated with the “Xiaomi router mini.”

Although FIGS. 5-7 respectively illustrate embodiments adopting the color, the icon and the texture as the identifying element, actually, a variety of forms may be combined with each other, for example, a combination of the color and the icon, a combination of the color and the texture, a combination of the icon and the texture and the like, or a combination of the color, the icon and the texture may be adopted, thus a more strongly marked effect is created in the visual and the association relationship of objects may be demonstrated.

Since the identifying elements indicates the association relationships of the plurality of associated objects in a visual form, the mobile phone may select the identifying element so that its property information matches and associates with a visual property of the corresponding associated object or a characteristic visual property of the corresponding associated object.

Take the “color” as an example, because the color of the “Xiaomi mobile phone” is a black color and a white color, the color of the “Xiaomi TV” is a golden color, the color of the “Xiaomi wristband” is a candy color (color like a candy), whereby it is possible to set the property of the corresponding identifying element “color”, so that the user may naturally think of the corresponding associated object when seeing a certain color, thus helping to reduce a amount of user's learning and improving a browsing efficiency.

Similarly, for the “icon”, a thumbnail image or a structure diagram of the associated object may be adopted directly, having a very high identifiability. For the “texture”, the texture pattern may be formed according to a surface material quality of each associated object, for example a texture of a back cover of the Xiaomi mobile phone; or the texture pattern may be formed by converting the icon of the associated object to the corresponding “texture”, in this way, the user may easily form an association between the texture and the associated object.

If the displayed object is corresponding to a plurality of associated objects, the identifying element may be an integrated identifying element obtained by performing an integrating process on a plurality of identifying elements corresponding respectively to the plurality of associated objects.

For example, for the “color”, if the “Xiaomi router” is corresponding to the “Xiaomi TV” and the “Xiaoyi intelligent camera”, and the “Xiaomi TV” is corresponding to the “golden”, the “Xiaoyi intelligent camera” is corresponding to the “white”, the color block corresponding to each object may be adopted to present the form shown in FIG. 5; or the integrating process is performed on the “golden” and the “white” to form the integrated identifying element, such as a “golden and white” color, thus only one color block designated by this “golden and white” color is required to be displayed.

Similarly, the integrating process may be performed on a plurality of icons or a plurality of textures to form the corresponding integrated identifying element.

In addition, similar to FIGS. 5-7, the corresponding identifying elements may be displayed in the detail page illustrated in FIG. 3B, here, taking the detail page of the “Xiaomi wristband” illustrated in FIG. 3B as an example, the display of the identifying element will be described as follows.

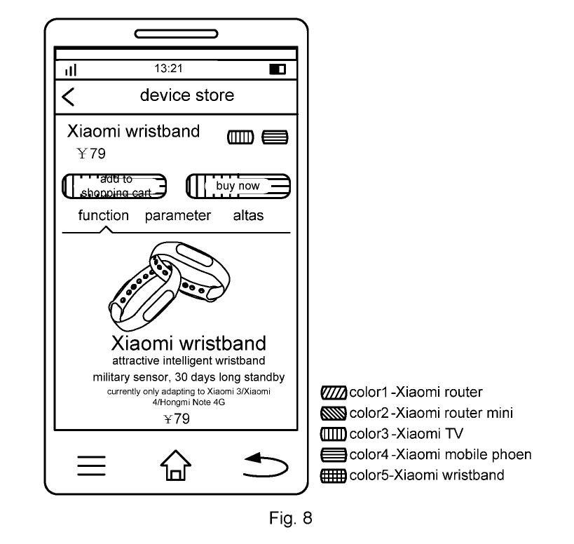

As shown in FIG. 8, assume that the “Xiaomi wristband” is associated with the “Xiaomi TV” and the “Xiaomi mobile phone.” As an exemplary embodiment, in a form similar to the color blocks illustrated in FIG. 5, the color blocks corresponding respectively to the “Xiaomi TV” and the “Xiaomi mobile phone” are shown to display the color 3 and color 4 at the right side of the text “Xiaomi wristband.” Or as another exemplary embodiment, for function buttons such as “add to shopping cart”, “buy now” and the like in the page, color properties of these function buttons may be set according to the colors corresponding to the “Xiaomi TV” and the “Xiaomi mobile phone.”

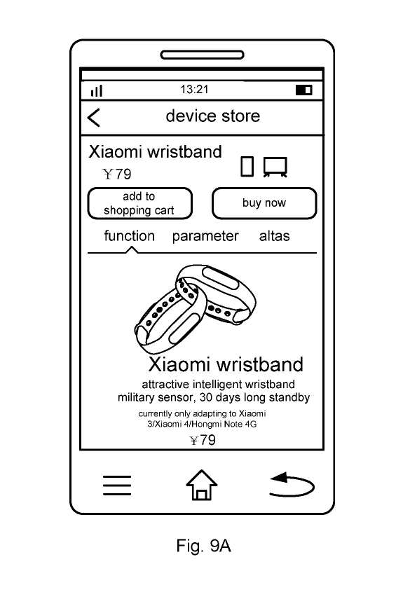

FIG. 9A illustrates the identifying element of the associated object based on the form of the “icon”, for example, icons corresponding respectively to the “Xiaomi TV” and the “Xiaomi mobile phone” may be displayed at the right side of the text “Xiaomi wristband.” FIG. 9B illustrates the identifying element of the associated object based on the form of the “texture”, for example, the horizontal stripe pattern and the vertical stripe pattern corresponding respectively to the “Xiaomi TV” and the “Xiaomi mobile phone” may be displayed at a position where the text “Xiaomi wristband” is at.

4. Trigger Operation to the Identifying Element

Based on the identifying element, the association relationship between the displayed object and the associated object may be established. It is easy for the user to understand the association relationships of objects; based on this, in the page on which the displayed object is, the user may be likely to want further information of the associated object, so following operations may be performed.

(1) Detecting, by the mobile phone, a trigger operation to the identifying element;

(2) Displaying, by the mobile phone, a display page of an associated object corresponding to a triggered identifying element; or displaying a floating page floating over the current display page, and displaying information of an associated object corresponding to a triggered identifying element on the floating page.

There may be two processing ways to perform operation (2), and in the following, take the identifying element in the form of the “icon” as an example to explain each processing way.

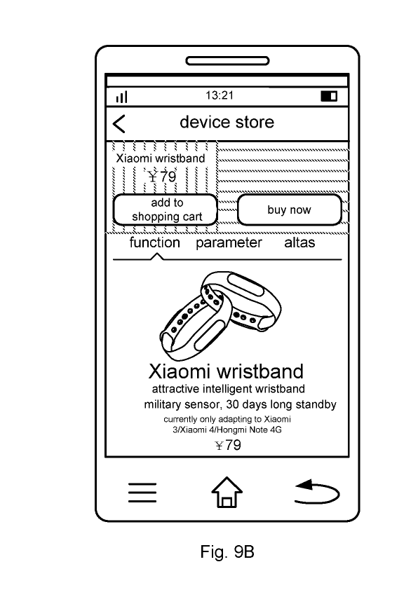

As an exemplary embodiment, as shown in FIG. 10A, the user may click the “Xiaomi TV” icon with his/her finger directly in the detail page of the “Xiaomi wristband” to trigger an information browse of the associated object “Xiaomi TV.” As shown in FIG. 10B, the detail page of the “Xiaomi TV” is directly displayed for responding to the trigger operation of the user, such that the user may directly browse the details of the “Xiaomi TV” in this page.

If the user hopes to return to the detail page of the “Xiaomi wristband”, the user may directly trigger the “Xiaomi wristband” icon in the detail page of the “Xiaomi TV” illustrated in FIG. 10B, and then the detail page of the “Xiaomi wristband” is displayed; or the user may click a return key “<” at the upper left corner of the detail page of the “Xiaomi TV” to return to the previous page (i.e. the detail page of the “Xiaomi wristband”).

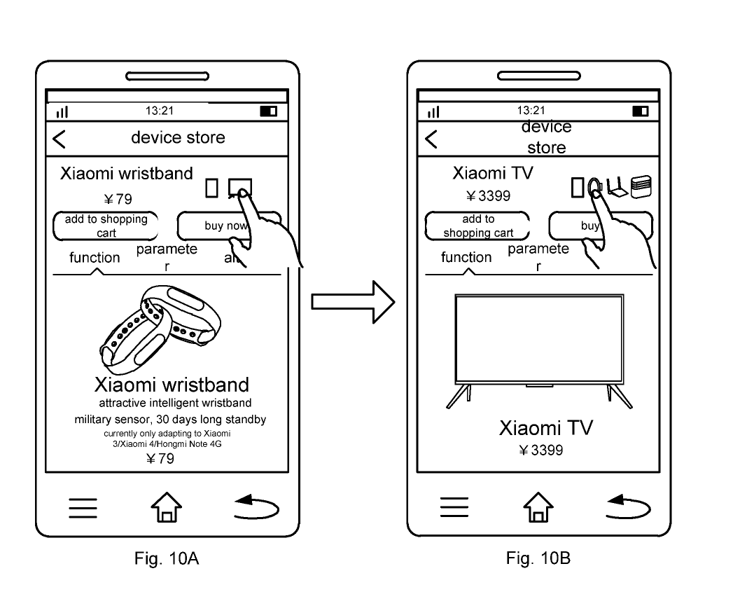

As another exemplary embodiment, as shown in FIG. 11A, the user may click the “Xiaomi TV” icon with his/her finger directly in the detail page of the “Xiaomi wristband” to trigger an information browse of the associated object “Xiaomi TV.” As shown in FIG. 11B, a floating page (such as a “bubble” window illustrated in FIG. 11B) is displayed to float over the detail page of the “Xiaomi wristband” for responding to the trigger operation of the user, and the information of the “Xiaomi TV” may be displayed in this floating page. The detailed information of the “Xiaomi TV” may be displayed in the floating page, similar to the situation that the content in the detail page illustrated in FIG. 10B is displayed in the floating page, or a brief content illustrated in FIG. 11B may be displayed so that the user may click a “learn more” button in the floating page to display the detail page illustrated in FIG. 10B.

If the user hopes to return to the detail page of the “Xiaomi wristband”, the user may directly trigger the “Xiaomi wristband” icon in the floating page to display the detail page of the “Xiaomi wristband”; or the user may click an area not covered by the floating page in the detail page of the “Xiaomi wristband” to cancel the display of the floating page and to return to the detail page of the “Xiaomi wristband.”

Corresponding to the above-described embodiments of the page display method, the present disclosure also provides embodiments of page display apparatus.

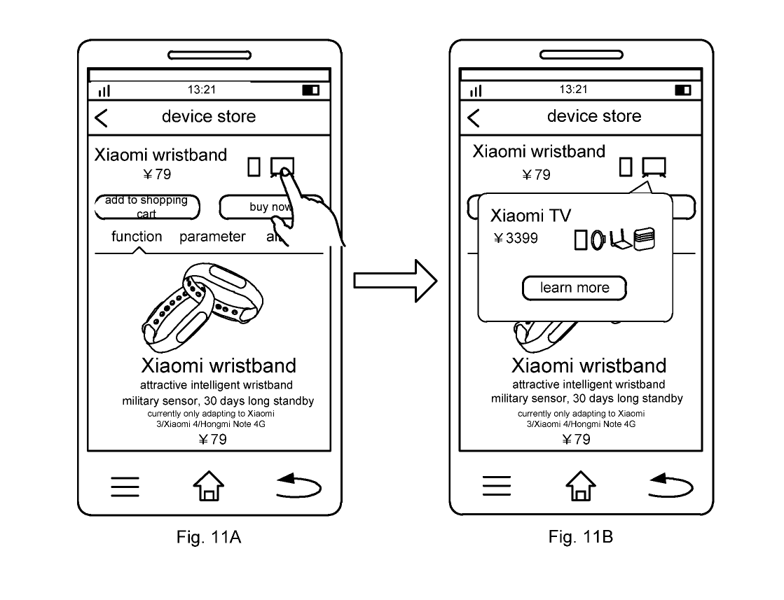

FIG. 12 is a block diagram showing a page display apparatus according to an exemplary embodiment. The page display apparatus may be the device 1400. For example, the display apparatus may include an obtaining unit 1202 and a displaying unit 1204.

The obtaining unit 1202 is configured to obtain an identifying element applied to a current display page, in which the identifying element matches an associated object of a displayed object in the current display page.

The displaying unit 1204 is configured to display the identifying element in a display area associated with the displayed object and in the current display page.

Alternatively, if the associated object is a whole device, the displayed object is an accessory of the whole device, or is another whole device cooperated with the whole device.

If the associated object is an accessory, the displayed object is a whole device corresponding to the accessory, or is another accessory applied to a same whole device with the accessory.

Alternatively, the identifying element includes at least one of a color, a texture and an icon.

Alternatively, property information of the identifying element matching the associated object is associated with a visual property of the associated object.

Alternatively, if the displayed object is corresponding to a plurality of associated objects, the identifying element is an integrated identifying element obtained by performing an integrating process on a plurality of identifying elements corresponding respectively to the plurality of associated objects.

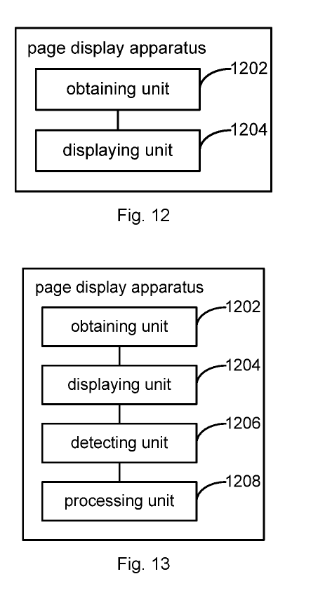

As shown in FIG. 13, in which FIG. 13 is a block diagram showing another page display apparatus according to an exemplary embodiment, this embodiment may further include a detecting unit 1206 and a processing unit 1208 based on the embodiment shown in FIG. 12.

The detecting unit 1206 is configured to detect a trigger operation to the identifying element.

The processing unit 1208 is configured to jump to a display page of an associated object corresponding to a triggered identifying element; or is configured to overlap a floating page on the current display page, and to display information of an associated object corresponding to a triggered identifying element in the floating page.

With respect to the apparatuses in the above embodiments, the specific manners for performing operations for individual modules therein have been described in detail in the embodiments regarding the method embodiments, which are not elaborated herein again.

According to the above exemplary embodiments, the present disclosure provides systems and methods that may recommend relevant products to an object that a user is browsing through a terminal device. The relevant products may be generally relevant to the object, or alternatively, the relevant products may be limited only to specific products, such as products and/or parts that can be used by the object. For example, if the user is browsing a particular model of a cell phone, the relevant product may be parts of the cell phone or products that have been proved to be applicable and/or implementable in the cell phone, such as protective cases or protective screens specially designed for the cell phone of the particular model. The relevant and/or recommended product may be pre-determined and/or pre-defined for the particular object, rather than randomly selected.

For the apparatus embodiments, since they substantially correspond to the method embodiments, concerning related parts of the device embodiments, reference is made to corresponding parts of the method embodiments The above-described apparatus embodiments are merely illustrative, in which a unit as a separate component may or may not be physically separated, a component displayed as a unit may or may not be a physical unit, i.e. may be located at a place, or be distributed on multiple network units. According to the actual need to select parts or all of the modules to achieve the purpose of the present disclosure. A part or all of the modules may be selected according to practical needs so as to achieve the object of the solution of the present disclosure, which may be understood and implemented by those skilled in the art without creative labor.

Accordingly, the present disclosure also provides a page display apparatus, including: a processor; a memory for storing instructions executable by the processor; in which the processor is configured to: obtain an identifying element applied to a current display page, in which the identifying element matches an associated object of a displayed object in the current display page; display the identifying element in a display area associated with the displayed object and in the current display page.

Accordingly, the present disclosure also provides a terminal, and the terminal includes a memory, and one or more programs, in which the one or more programs are contained in the memory, and are configured to be executed by one or more processors, and include instructions for performing following operations of obtaining an identifying element applied to a current display page, in which the identifying element matches an associated object of a displayed object in the current display page; displaying the identifying element in a display area associated with the displayed object and in the current display page.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

1. An electronic device, comprising:
a processor-readable storage medium including a set of instructions for displaying a page; and
a processor in communication with the storage medium, wherein when executing the set of instructions, the processor is directed to:
display a current display page on a screen of the electronic device;
display a displayed object on a current display page, wherein the displayed object has a predetermined association relationship with an associated object;
obtaining an identifying element indicating the predetermined association relationship; and
display the identifying element on the current display page.

2. The device according to claim 1, wherein the displayed object and the associated device are:
a plurality of independent devices that each is configured to perform part of a predetermined function and when used together are configured to complete the predetermined function;
a whole device and at least one accessory of the whole device; or
at least one accessory of a whole device.

3. The device according to claim 1, wherein the identifying element comprises a property matches and associates with a characteristic visual property of the associated object.

4. The device according to claim 3, wherein the identifying element comprises at least one of a color, a texture, and an icon associated with the associated object; and
the processor is further directed to display the identifying element in a display area associated with the displayed object.

5. The device according to claim 1, wherein when the displayed object is corresponding to a plurality of associated objects and when each associated object is associated with an identifying element, the identifying element of the displayed object incorporates the plurality of identifying elements of the plurality of associated objects.

6. The device according to claim 1, wherein the processor is further directed to:
detect a trigger operation taken to the identifying element; and
display the associated object corresponding to the identifying element.

7. The method according to claim 6, wherein the associated object is displayed on the current display page or on a floating page floating over the current display page.

8. A method for displaying a page, comprising:
displaying, by an electronic device, a current display page on a screen of the electronic device;
displaying, by the electronic device, a displayed object on a current display page, wherein the displayed object has a predetermined association relationship with an associated object;
obtaining, by the electronic device, an identifying element indicating the predetermined association relationship; and
displaying, by the electronic device, the identifying element on the current display page.

9. The method according to claim 8, wherein the displayed object and the associated device are:
a plurality of independent devices that each is configured to perform part of a predetermined function and when used together are configured to complete the predetermined function;
a whole device and at least one accessory of the whole device; or
at least one accessory of a whole device.

10. The method according to claim 8, wherein the identifying element comprises a property matches and associates with a characteristic visual property of the associated object.

11. The method according to claim 10, wherein the identifying element comprises at least one of a color, a texture, and an icon associated with the associated object; and
the identifying element is displayed in a display area associated with the displayed object.

12. The method according to claim 8, wherein when the displayed object is corresponding to a plurality of associated objects and when each associated object is associated with an identifying element, the identifying element of the displayed object incorporates the plurality of identifying elements of the plurality of associated objects.

13. The method according to claim 8, further comprising:
detecting, by the electronic device, a trigger operation taken to the identifying element; and
displaying, by the electronic device, the associated object corresponding to the identifying element.

14. The method according to claim 13, wherein the associated object is displayed on the current display page or on a floating page floating over the current display page.

15. A non-transitory processor-readable storage medium, comprising a set of instructions for displaying a page, wherein when executed by a processor of an electronic device, the set of instruction directs the processor to perform:
displaying a current display page on a screen of the electronic device;
displaying a displayed object on a current display page, wherein the displayed object has a predetermined association relationship with an associated object;
obtaining an identifying element indicating the predetermined association relationship; and
displaying the identifying element on the current display page.

16. The method according to claim 15, wherein the displayed object and the associated device are:
a plurality of independent devices that each is configured to perform part of a predetermined function and when used together are configured to complete the predetermined function;
a whole device and at least one accessory of the whole device; or
at least one accessory of a whole device.

17. The method according to claim 15, wherein the identifying element comprises a property matches and associates with a characteristic visual property of the associated object.

18. The method according to claim 17, wherein the identifying element comprises at least one of a color, a texture, and an icon associated with the associated object; and
the identifying element is displayed in a display area associated with the displayed object; and.

19. The method according to claim 15, wherein when the displayed object is corresponding to a plurality of associated objects and when each associated object is associated with an identifying element, the identifying element of the displayed object incorporates the plurality of identifying elements of the plurality of associated objects.

20. The method according to claim 15, further comprising:
detecting, by the electronic device, a trigger operation taken to the identifying element; and
displaying, by the electronic device, the associated object corresponding to the identifying element on the current display page or on a floating page floating over the current display page.
